(19) United States
(12) Patent Application Publication
(10) Pub. No.: US 2004/0170533 A1
(43) Pub. Date: Sep. 2, 2004

(54) Syringe for medical tests

(76) Inventor: Yu-Hui Chu, Taipei (TW)

Correspondence Address: RABIN & BERDO, P.C., Suite 500, 1101 14 Street, N.W., Washington, DC, 20005, US

(21) Appl. No.: 10/374,069

(22) Filed: Feb. 27, 2003

(51) Int. Cl. B01L 3/00

(52) U.S. Cl. 422/100; 422/99

(57) ABSTRACT

The present invention is a syringe for medical tests that comprises an adaptor arranged on one end of a barrel, a needle arranged on inner side of the adaptor, and a plunger disposed on rear end of the barrel. A plurality of different reagents is filled inside the barrel. The device features on that a plurality of soft plastic sleeve with various length is disposed inside the barrel so as to form a plurality of cell between two adjacent soft plastic sleeves for accommodating reagents and a plunger is inserted on an opening of the last soft plastic sleeve for sealing reagent therein.

### BACKGROUND OF THE INVENTION

1. Field of the Invention

The present invention relates to a syringe for medical tests, especially to a syringe that includes a plurality of cells with various reagents therein. A plurality of soft plastic sleeve is disposed inside a barrel of the syringe so as to form a cell between two adjacent sleeves. Thus the structure of the syringe is simplified, the manufacturing cost is decreased, and the market competitiveness is increased.

2. Description of the Prior Art

In general medical tests, different kinds of reagents are dropped on the sample. Each reagent with different dosage need to be drawn out from the vials by different droppers so as to avoid the mixing of reagents before reacting with sample and obtain the correct results.

It's trouble to change droppers while take each kind reagents.

Moreover, the amount of reagents dropped from the dropper is difficult to measure. Thus the inaccuracy of the reagent amount will have bad effect on the test result. Especially to the youngling who has less experience in controlling the dropping amount, the test result is more easier to have error.

In order to improve above shortcomings, a device as shown in FIG. 3 and FIG. 4 is disclosed. The reagents for tests are packaged inside each of capsules (b1), (b2), (b3) respectively. Then the capsules (b1), (b2), (b3) with reagents (a1), (a2), (a3) are disposed inside a barrel (c) by the order dropping on the sample. A needle (c2) is installed inside an adapter (c1) on one end of the barrel (c) while a plunger (d) is inserted into an opening of the barrel (c) on the other end. By pushing the plunger (d), the capsules (b1), (b2), (b3) is moving towards and is penetrated by the needle (c2) so that the reagents (a1), (a2), (a3) inside is released from the adapter (c1) to react with samples.

But the reagents (a1), (a2), (a3) need to be packed and sealed inside the capsules (b1), (b2), (b3) respectively thus the manufacturing process is complicated, causing the increasing of cost.

Another prior art, as shown in FIG. 5 and FIG. 6, a plurality of baffle (e) divides the space inside the barrel (c) into a plurality of small compartments, each of which is filled with different reagents (al ), (a2), (a3). Similarly, the reagents (al), (a2), (a3) are released by the plunger (d) pushing the baffle (e) towards the needle (c2) and the baffle (e) being pierced.

However the sealing effect of the baffle (e) is not ideal enough to separate two different reagents (al), (a2), or (a3). Thus the two reagents (al), (a2), or (a3) will infiltrate to other compartment and react with other reagents. Therefore, the test results may be biased. Moreover, the baffle (e) may not move smoothly while being pushed. Once the baffle (e) is inclined, there is a crevice between the inner wall of the barrel (c) and the baffle (e) thus the reagents (al ), (a2), or (a3) will also leak to other compartment. There is a need to improve.

### SUMMARY OF THE INVENTION

Therefore it is a primary object of the present invention to provide a syringe for medical tests includes an adapter with a needle inside disposed on one end of a barrel, a plunger installed on the rear end of the barrel. The

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an explosive view of the present invention;

FIG. 2 is a cross sectional view of the present invention;

FIG. 3 is an explosive view of a prior art;

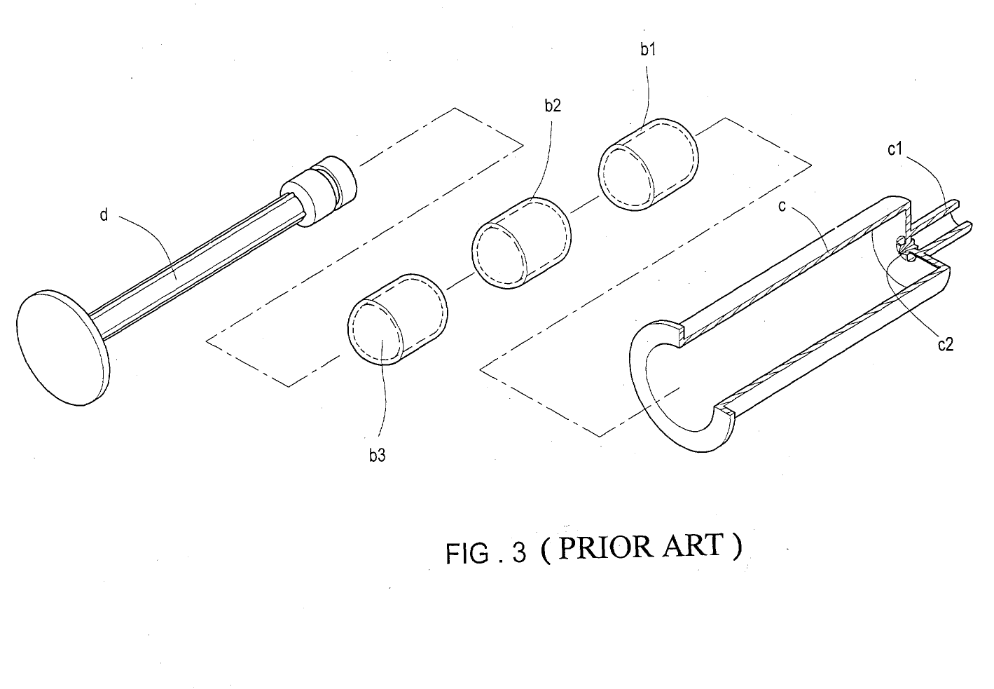

FIG. 4 is a cross sectional view of the prior art;

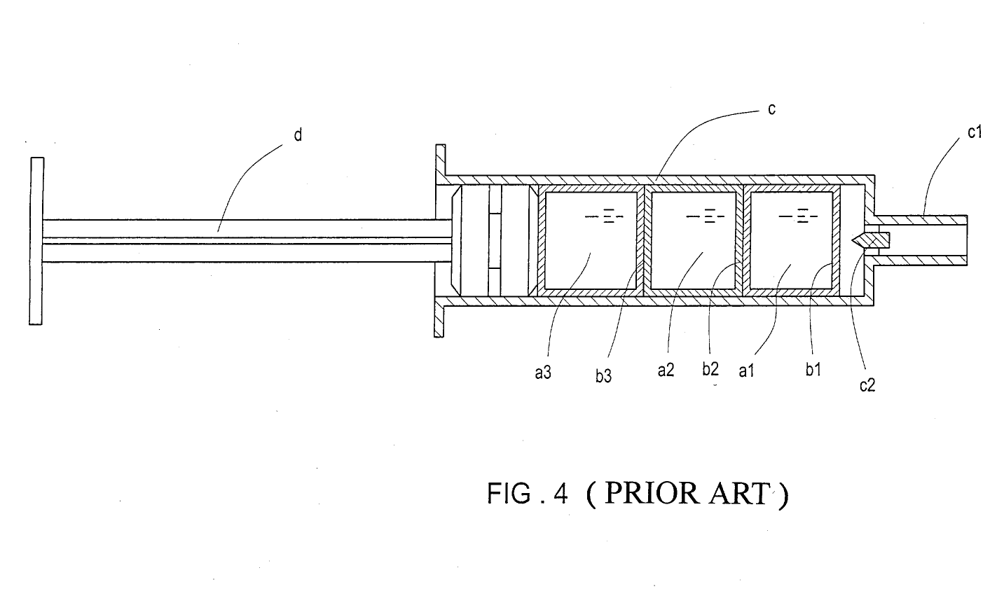

FIG. 5 is an explosive view of another prior art;

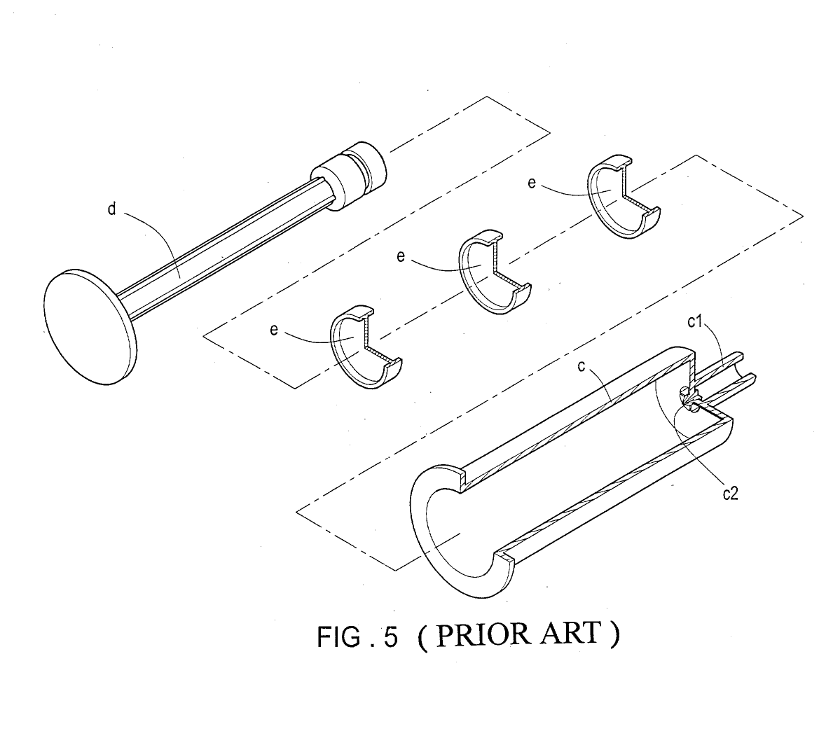

FIG. 6 is a cross sectional view of another prior art.

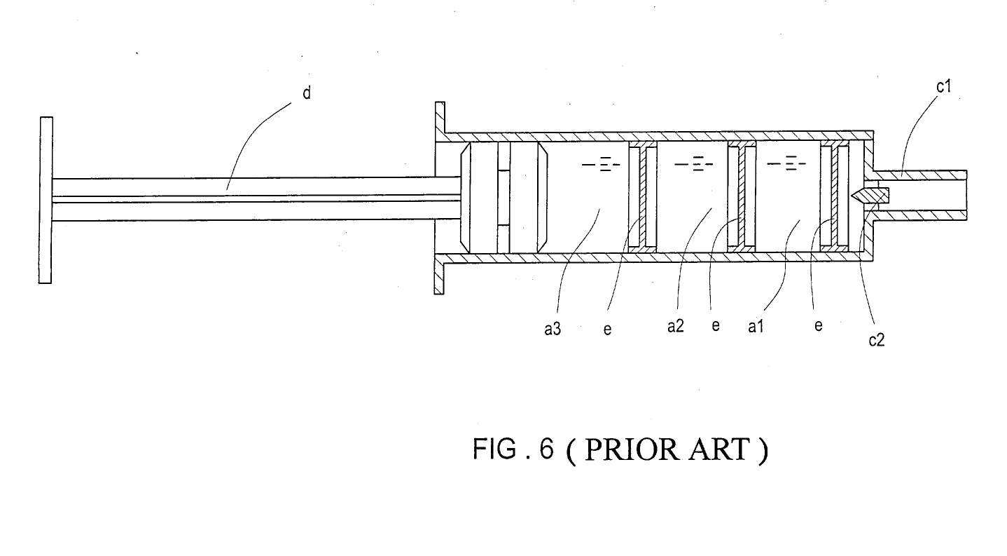

### DETAILED DESCRIPTION OF THE PREFERRED EMBODIMENT

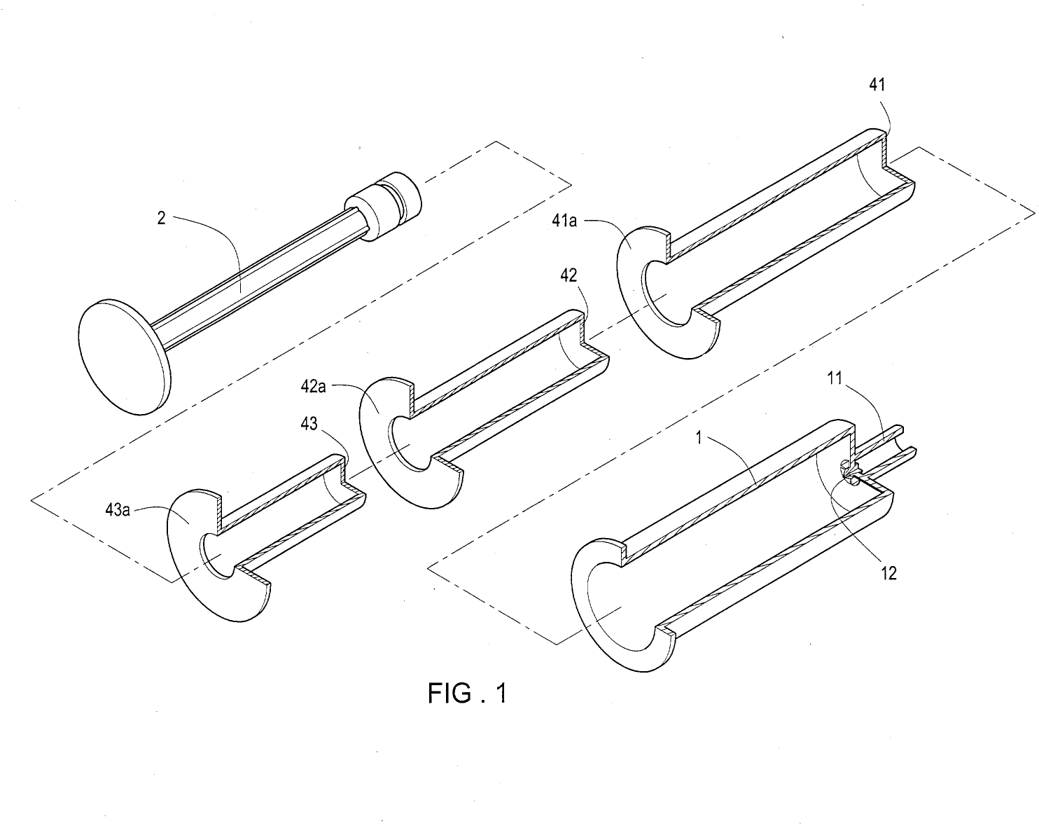

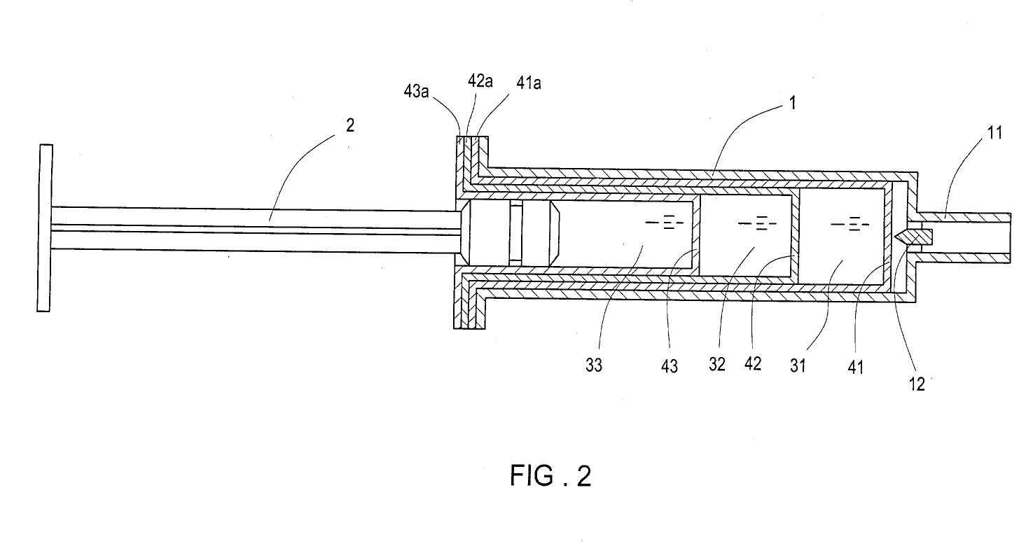

Refer to FIG. 1 & FIG. 2, the present invention is composed by an adapter 11 with a needle 12 on inner end thereof arranged on one end of a barrel 1 and a plunger 2 mounted on rear end of the barrel 1. A plurality of reagents 31, 32, 33 are filled into the barrel 1 respectively. The device features on that a plurality of soft plastic sleeve 41, 42, 43 with different length is disposed into the barrel 1 in order so as to form a plurality of cell between the two adjacent soft plastic sleeves 41, 42, or 43. A plurality of different kind of reagents 31, 32, 33 are filled into each of the cell respectively.

The plunger 2 is arranged on that opening of the last soft plastic sleeve 43 for sealing the reagent therein.

In accordance with the structure mentioned above, while pushing the plunger 2 on the rear side of the barrel 1, the soft plastic sleeves 41, 42, 43 move in turn toward the needle 12 so that the needle 12 penetrates each of the soft plastic sleeves 41, 42, 43 by the number and make the reagents 31, 32, 33 releasing from the soft plastic sleeves 41, 42, 43, thus flowing through the adaptor 11. Therefore, the reagents 31, 32, 33 drop on the sample in turn thus chemical reaction happen.

Due to the tubular shape of the soft plastic sleeves 41, 42, 43, there is no need to seal openings of each of the sleeves 41, 42, 43. Thus the packaging procedure is simplified and the manufacturing cost is also reduced. Therefore, the market competitiveness is increased.

Moreover, the soft plastic sleeves 41, 42, 43 are disposed into the barrel 1 in turn respectively and having different length, thus the cells are completely separated. Even during the pushing process, each of the soft plastic sleeves 41, 42, 43 keeps separated so as to avoid the problem of filtration of reagents 31, 32, 33. Furthermore, each of the soft plastic sleeves 41, 42, 43 has a projecting ring 41a, 42a, 43a lean against the opening end thereof so that the opening of each of the soft plastic sleeves 41, 42, 43 is fixed firmly inside the barrel 1. While being pushed by the plunger 2, the soft plastic sleeves 41, 42, 43 won't slide. This is another embodiment of the present invention.

In addition, the projecting ring 41a, 42a, 43a of the soft plastic sleeves 41, 42, 43 can be glued firmly on the opening of the barrel 1 so that the opening end of the soft plastic sleeves 41, 42, 43 is totally affixed. Thus the soft plastic sleeves 41, 42, 43 won't be sliding during the pushing process. This is a further embodiment.

It should be noted that the above description and accompanying drawings are only used to illustrate some embodiments of the present invention, not intended to limit the scope thereof. Any modification of the embodiments should fall within the scope of the present invention.

What is claimed is:

1. A syringe for medical tests comprising
an adaptor arranged on one end of a barrel,
a needle arranged on inner side of said adaptor,
a plunger disposed on rear end of said barrel; various kind of reagents are filled inside said barrel; the improvement of the invention is characterized in that
a plurality of soft plastic sleeve with various length is disposed inside said barrel so as to form a plurality of cell between two adjacent said soft plastic sleeves for accommodating reagents; said plunger is inserted on an opening of the last said soft plastic sleeve for sealing reagent therein.

2. The syringe for medical tests as claimed in claim 1, wherein a projecting ring is disposed on an opening of each of said soft plastic sleeves; said projecting ring is lean against an opening end of said barrel

3. The syringe for medical tests as claimed in claim 1, wherein a projecting ring is disposed on an opening of each of said soft plastic sleeves; said projecting ring is glued firmly on an opening end of said barrel
